(19) United States
(12) Patent Application Publication
(10) Pub. No.: US 2020/0147737 A1
(43) Pub. Date: May 14, 2020

(54) DEVICE FOR DETECTING ABNORMALITY IN ATTACHMENT OF TOOL

(71) Applicant: FANUC CORPORATION, Yamanashi (JP)

(72) Inventor: Yasuhiro NAKAHAMA, Yamanashi (JP)

(21) Appl. No.: 16/680,510

(22) Filed: Nov. 12, 2019

(30) Foreign Application Priority Data
Nov. 14, 2018 (JP) 2018-214212

(51) Int. Cl. B23Q 3/155

(52) U.S. Cl. CPC B23Q 3/155

(57) ABSTRACT

A tool attachment abnormality detection device acquires data associated with a machining center, performs pre-processing to create data regarding at least chronological data of a vibration or sound that has been generated in a tool change when a tool has been attached to a tool magazine, where the data is created based on the data that has been acquired, and detects an abnormality in attachment of the tool to the tool magazine based on the data created in the pre-processing stage.

### RELATED APPLICATIONS

The present application claims priority to Japanese Patent Application Number 2018-214212 filed on Nov. 14, 2018, the disclosure of which is hereby incorporated by reference herein in its entirety.

### BACKGROUND OF THE INVENTION

### 1. Field of the Invention

The present invention relates to a device for detecting an abnormality in attachment of a tool.

### 2. Description of the Related Art

Machine tools equipped with an automatic tool changer, in particular, typical machining centers are widely used in the field of machine tools. Such a typical machining center includes a tool magazine that accommodates a plurality of tools each attached to a tool holder. The machining center selects a predetermined tool by an indexing action of the tool magazine to move the selected tool to a predetermined position, and detaches the tool along with its tool holder from the tool magazine by a tool change action by a tool change arm or the like to bring the tool into fitting engagement with a main spindle and use the tool in a process of machining (for example, see International Publication No. 93/18884, i.e., Japanese Patent Laid-Open Application No. 05-261638 (Patent Document 1)).

As examples of traditional technologies for detecting abnormalities in such a tool change action, Japanese Patent No. 4501918 (Patent Document 2) and Japanese Patent Laid-Open Application No. 11-333657 (Patent Document 3), which are the Patent Documents described later, as well as the above-mentioned Patent Document 1 disclose technologies for detecting abnormalities associated with the attitude in which the tool is attached to the tool magazine, tool change action, and the attachment state of the tool to the main spindle in machine tools including an automatic tool changer.

A tool magazine includes a plurality of mechanical hand grippers which grasp the tool holder by the elastic force of a spring. When a tool is to be attached to the tool magazine, positioning of the tool relative to the tool holder is actualized such that a keyway of the tool holder to which the tool is fitted corresponds to a positioning key provided on the gripper, the tool holder is pressed into the gripper, and thereby the tool holder is grasped by the gripper.

At this point, due to a mistake by an operator or the like, the tool holder in some cases may not be correctly attached to the gripper. In such a case, the tool may be detached from the tool magazine or collide with the main spindle as a result of the tool change action, which may cause damage to a rotation tool and the main body of the machine.

In order to address such a problem, an abnormality in the attachment state of a tool relative to a main spindle can be detected according to the technology disclosed in Patent Document 2. However, a gripper provided in a tool magazine cannot detect the attachment state of the tool relative to its tool holder. Also, the technology disclosed in Patent Document 3 is only capable of detecting abnormalities associated with a tool change action.

Also, according to the technology disclosed in Japanese Patent Laid-Open Application No. 2005-324262 (Patent Document 4), whether or not the attitude of a tool attached to a tool magazine is correct can be detected. However, for example, the tool may be attached to the tool magazine seemingly in a correct attitude while the gripper actually fails to completely grasp the tool holder due to chips adhering to the attachment section of the tool holder to the gripper. Accordingly, it is difficult for the technologies disclosed in the above-identified Patent Documents to detect such an abnormal state of attachment of a tool.

### SUMMARY OF THE INVENTION

In view of the above-described circumstances, an object of the present invention is to provide a device capable of accurately detecting an abnormality in attachment of a tool to a tool magazine.

According to the present invention, a vibration or sound acting upon the tool changer (in particular, a tool magazine) when an operator attaches a tool (more specifically, a tool holder to which the tool is attached) to a tool magazine is used as state data. Machine learning is carried out to learn, for example, at least either the vibration or sound when the tool is correctly attached and the vibration or sound when the tool is not correctly attached and the normality/abnormality in attachment of the tool is estimated using the result of the learning to solve the above-identified problem. At the time of attachment of a tool to a tool magazine, when a mechanical hand gripper grasps the tool holder by an elastic force of a spring or the like, predetermined sections thereof are brought into fitting engagement with each other, which causes a particular vibration or sound to be generated. However, if chips adhere to the attachment section of the tool holder and hinder grasping of the tool holder by the gripper or pressing of the tool by the operator is incomplete, such a vibration or sound is not generated but a different vibration or sound is generated. As a result, when a learning model for learning the vibrations or sounds at the time of normal and abnormal operations by the machine learning is created, it is made possible to estimate the difference therebetween and detect normality/abnormality in attachment of a tool.

In addition, an aspect of the present invention provides a device for detecting an abnormality in attachment of a tool to a tool magazine in a tool changer provided in a machining center, where the device includes a data acquisitor for acquiring data regarding the machining center; a pre-processor for creating data regarding at least chronological data of vibration or sound generated in the tool changer when the tool is attached to the tool magazine, the data regarding the at least chronological data being created based on the data acquired by the data acquisitor; and a tool attachment abnormality detector for detecting an abnormality in attachment of the tool to the tool magazine based on the data created by the pre-processor.

Another aspect of the present invention provides a device for detecting an abnormality in attachment of a tool to a tool magazine in a tool changer provided in a machining center, where the device includes a data acquisitor for acquiring data regarding the machining center; a pre-processor for creating state data that includes at least tool attachment vibration data regarding chronological data of a vibration or sound generated in the tool changer when the tool is attached to the tool magazine, the state data being created as learning data based on the data acquired by the data acquisitor; and a tool attachment abnormality detector configured for detection of an abnormality in attachment of the tool to the tool magazine based on the data created by the pre-processor. The tool attachment abnormality detector includes a learner for performing machine learning using learning data created by the pre-processor and further creating a learning model for detection of an abnormality in attachment of the tool to the tool magazine.

A still another aspect of the present invention provides a device for detecting an abnormality in attachment of a tool to a tool magazine in a tool changer provided in a machining center and includes a data acquisitor for acquiring data regarding the machining center; a pre-processor for creating state data that includes at least tool attachment vibration data regarding chronological data of a vibration or sound generated in the tool changer when the tool is attached to the tool magazine, the state data being created based on the data acquired by the data acquisitor; and a tool attachment abnormality detector for detecting an abnormality in attachment of the tool to the tool magazine based on the data created by the pre-processor. The tool attachment abnormality detector includes a learning model storage configured to store a learning model for learning an attachment state of the tool attached to the tool magazine with respect to chronological data of the vibration or sound generated in the tool changer when the tool is attached to the tool magazine; and an estimator configured to estimate the attachment state of the tool attached to the tool magazine by using the learning model stored in the learning model storage, the attachment state being estimated based on state data created by the pre-processor.

According to the present invention, it is made possible to estimate the attachment state of a tool with high precision, which in turn makes it possible to reduce the possibility of erroneous operation at the time of attaching the tool by an operator. Also, according to the present invention, because it is possible to estimate the attachment state of the tool using one single sensor or a small number of sensors, errors in attachment of tools can be detected with reduced costs.

### BRIEF DESCRIPTION OF THE DRAWINGS

The above-described and other objects and features will be apparent upon reading of the following description of embodiments with reference to the accompanying drawings, in which:

FIG. 1 is a hardware configuration diagram schematically illustrating a tool attachment abnormality detection device according to a first embodiment of the present invention;

FIG. 2 is a functional block diagram schematically illustrating the device according to the first embodiment;

FIG. 3 is a hardware configuration diagram schematically illustrating a tool attachment abnormality detection device according to a second or a third embodiment of the present invention;

FIG. 4 is functional block diagram schematically illustrating the device according to the second embodiment;

FIG. 5 is a diagram illustrating an example of a learning model created by unsupervised learning in the device according to the second embodiment.

FIG. 6 is a diagram illustrating an example of a learning model created by supervised learning in the device according to the second embodiment;

FIG. 7 is a functional block diagram schematically illustrating the device according to the third embodiment of the present invention;

FIG. 8 is a diagram illustrating an example of estimation of normality/abnormality in attachment of a tool using the learning model created by the unsupervised learning in the device according to the third embodiment;

FIG. 9 is a diagram illustrating an example of estimation of normality/abnormality in attachment of a tool using the learning model created by the supervised learning in the device according to the third embodiment; and

FIG. 10 is a diagram illustrating an embodiment of the tool attachment abnormality detection device for estimating normality/abnormality in attachment of a tool of a plurality of machining centers.

### DETAILED DESCRIPTION OF THE PREFERRED EMBODIMENTS

Some embodiments of the present invention will be described hereinbelow with reference to the drawings.

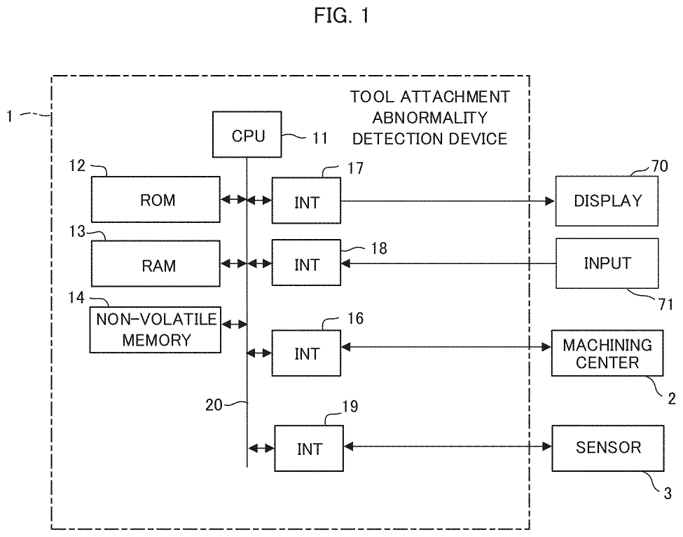

FIG. 1 is a hardware configuration diagram schematically illustrating the principal part of a device for detecting an abnormality in attachment of a tool and includes a machine learner according to a first embodiment (which may also be referred to as a “tool attachment abnormality detection device” or simply as “the device 1”). For example, the device 1 according to this embodiment can be implemented on a control device that controls a machining center 2. Also, the device 1 according to this embodiment can be mounted as a personal computer fitted with the controller that controls the machine center or as a computer such as an edge computer, cell computer, host computer, and cloud server connected via a wired or wireless network to the controller. In this embodiment, the device 1 is implemented as a personal computer fitted with the controller that controls the machining center 2.

Referring to FIG. 1, the tool attachment abnormality detection device 1 may include a central processing unit (CPU) 11, a read only memory (ROM) 12, a random access memory (RAM) 13, a non-volatile memory 14 and a plurality of interfaces 16 to 19.

The central processing unit (CPU) 11, which is included in the device 1 according to this embodiment, is a processor that is responsible for overall control of the device 1. The CPU 11 reads system programs stored in the read only memory (ROM) 12 via a bus 20 and controls the entire device 1 in accordance with the system programs. The random access memory (RAM) 13 may temporarily store temporary calculation data and other various data input by an operator via an input 71.

The non-volatile memory 14 is configured by a memory backed up by a not-shown battery, a solid state drive (SSD) or the like and retains its state of storage even when the device 1 is turned off. The non-volatile memory 14 includes a setting area in which setting information regarding the operation of the device 1 is provided, and stores data input from the input 71, various data acquired from the machining center 2 (operation state regarding tool change, unit types of the machining center and so on), chronological data of various physical quantities acquired from the sensor 3 (vibrations, sounds and so on generated in a tool changer provided in the machining center 2), data read via a network and/or from a not-shown external storage. The programs and the various data stored in the non-volatile memory 14 may be stored in the RAM 13 when they are run or used. Also, system programs including a known analysis program for analyzing various data are stored in advance in the ROM 12.

The machining center 2 is a machine tool equipped with an automatic tool changer. The machining center 2 is capable of performing multiple types of machining processes such as milling, boring and drilling while changing various rotating tools with one another by the automatic tool changer. A plurality of tools each loaded in a tool holder are attached to the tool magazine by the operator. A tool grasped at a predetermined position of the tool magazine and attached thereto is attached to a main spindle of the machine tool to be used in an intended machining process in accordance with a tool change command by a machining program or the like. The controller of the machining center 2 outputs information regarding the state of the machining center (such as unit types of the machining center, an operation state of the machine tool, an open/close operation state of the cover and an operation state of the tool changer) to the device 1 via the interface 16.

The sensor 3 is configured to acquire chronological data of a vibration or sound generated in the tool changer provided in the machining center 2 (in particular, the tool magazine). For example, an acceleration sensor, an acoustic emission (AE) sensor, a sound collector, an optical interferometer and the like can be used as the sensor 3. At least one sensor 3 can sufficiently detect the vibration or sound generated in the tool changer. When a plurality of sensors 3 are installed on or near the tool changer, it is made possible to detect vibration or sound generated in the tool changer in a more multifaceted fashion, and precision of the machine learning which will be described later can be further improved. Alternatively, when the sensors 3 are installed at appropriate positions taking into account the structure of the tool magazine, it is also possible to sufficiently detect the vibration and sound generated in the tool changer by a single or a small number of sensor(s) 3.

Data read into the memory, data obtained as a result of execution of a program or the like, data output from the machine learning device 100, which will be described later, and any other relevant data may be output via the interface 17 to a display 70 and displayed on the display 70. Also, the input 71, which is configured with a keyboard, a pointing device and the like, transmits a command, data and so on based on the operation by the operator via the interface 18 to the CPU 11.

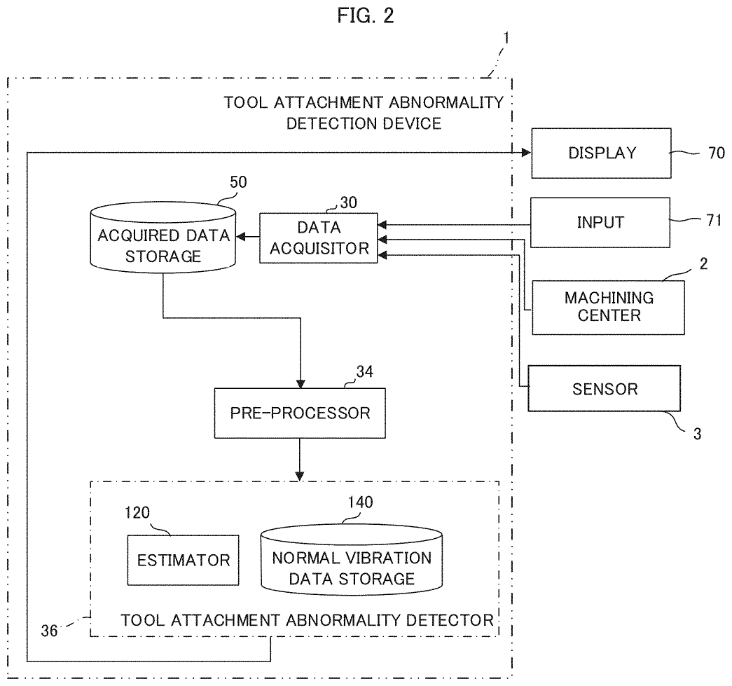

FIG. 2 is a functional block diagram schematically illustrating the tool attachment abnormality detection device 1 according to the first embodiment. The respective functional blocks illustrated in FIG. 2 are effectuated by the CPU 11 provided in the device 1 illustrated in FIG. 1 running the system programs and controlling the operations of the individual components in the device 1.

The device 1 according to this embodiment includes a data acquisitor 30, a pre-processor 34, and a tool attachment abnormality detector 36. The tool attachment abnormality detector 36 includes an estimator 120. Also, an acquired data storage 50 in which data acquired by the data acquisitor 30 is stored and a normal vibration data storage 140 are provided in the non-volatile memory 14.

The data acquisitor 30 is a functional unit that acquires various data input from the machining center 2, the sensor 3, the input 71 and the like. The data acquisitor 30 acquires various data such as the operation state regarding tool change, the unit types of the machining center 2, chronological data of the vibration or sound generated in the tool changer when the tool is attached to the tool magazine by the operator, information regarding attachment of the tool input by the operator, and stores these pieces of information in the acquired data storage 50. The data acquisitor 30 may also be configured to acquire data from a not-shown external storage or from other devices via a wired or wireless network.

When the data acquisitor 30 acquires the chronological data of the vibration or sound generated in the tool changer when the tool is attached to the tool magazine by the operator, the data acquisitor 30 identifies vibration or sound data indicative of vibration or sound generated in the tool changer acquired from the sensor 3 on the basis of the operation state of the machine tool acquired from the machining center 2, the open/close operation state of the cover, the operation state of the tool changer and the like. The data acquisitor 30 further identifies the vibration or sound data indicative of the vibration or sound generated in the tool changer when the tool is attached to the tool magazine by the operator. In general, when an operator performs various operations such as the task of attaching a tool to a tool magazine, he/she operates a control panel or the like, stops the machining by the machine tool, opens the cover, positions a certain gripper of the tool magazine at the tool attachment position to attach the tool thereto, closes the cover and thus completes the tool change. The data acquisitor 30 may detect such typical tool attachment operation to identify the vibration sound detected by the sensor 3 during such an operation as the vibration or sound data indicative of the vibration or sound generated in the tool changer when the tool is attached to the tool magazine by the operator. Also, if the pressure or the like associated with the tool magazine can be detected, then pressing of the tool by the operator against the tool magazine (tool attachment) can be detected on the basis of the state of the pressure. Thus, the pressure and/or the detected pressing of the tool by the operator may be used to identify the vibration or sound data indicative of the vibration or sound generated in the tool changer when the tool is attached to the tool magazine by the operator. It should be noted that examples of case where the pressure or the like of the tool magazine can be detected may include, amongst others, a case where a pressure sensor is independently installed and a case where the current of a motor for rotating the tool magazine can be detected. Also, if any other means are available for detecting the time point at which the operator attaches the tool to the tool magazine, the detected time point may also be relied upon in the identification.

The pre-processor 34 creates data used in a process for detecting an abnormality in attachment of a tool by the attachment abnormality detector 36 on the basis of the data acquired by the data acquisitor 30 (and the data stored in the acquired data storage 50). The pre-processor 34 creates data obtained by subjecting the data acquired by the data acquisitor 30 to conversion (quantification, normalization, sampling, etc.) into a unified format to be handled by the tool attachment abnormality detector 36. The pre-processor 34 may be configured to use data obtained by representing the chronological data of the vibration or sound generated in the tool changer at the time of attachment of the tool detected by the sensor 3 as affiliated data that has been subjected to re-sampling at a predetermined cycle. The pre-processor 34 may also be configured to use data indicative of the properties of the chronological data (for example, known Mel-frequency cepstrum coefficient).

The tool attachment abnormality detector 36 is a functional unit for detecting an abnormality in attachment of a tool on the basis of the data created by the pre-processor 34.

The estimator 120 provided in the tool attachment abnormality detector 36 is a functional unit that refers to normal vibration data stored in a normal vibration data storage 140 and estimates an abnormality in attachment of a tool to the tool magazine by an operator on the basis of the data created by the pre-processor 34. In the normal vibration data storage 140, chronological data of the vibration or sound detected by the sensor 3 when the operator correctly attached the tool to the tool magazine provided in the machining center 2 in advance is set as the normal vibration data.

The estimator 120 computes a degree of agreement between the chronological data of the vibration or sound generated in the tool changer acquired by data acquisitor 30 and the normal vibration data stored in the normal vibration data storage 140 by using a known waveform pattern matching scheme such as dynamic programming matching (DP matching) and hidden Markov model (HMM). If the degree of agreement that has been computed exceeds a predefined threshold, then the estimator 120 estimates that the attachment of the tool to the tool magazine has been correctly performed. Otherwise, the estimator 120 estimates otherwise that the attachment of the tool to the tool magazine is in an abnormal state. The estimator 120 may also be configured to compute a degree of abnormality in accordance with how far the degree of agreement between the chronological data of the vibration or sound generated in the tool changer acquired by data acquisitor 30 and the normal vibration data stored in the normal vibration data storage 140 is away from the predefined threshold.

In addition, when the estimator 120 has estimated that the attachment of the tool to the tool magazine is in an abnormal state, the tool attachment abnormality detector 36 may display the result of the estimation by the estimator 120 (normality/abnormality in attachment of the tool and, if occurrence of abnormality has been estimated, the degree of abnormality) on the display 70 and output the result of the estimation to transmit the result to a host computer, a cloud computer or the like via a not-shown wired or wireless network. The device 1 may also be configured to change the display state of the display 70 according to the magnitude of the degree of abnormality.

The normal vibration data storage 140 may store a plurality of pieces of normal vibration data acquired from the same machining center 2. In this case, the estimator 120 may carry out the estimation process to estimate the attachment state of the tool relative to the tool magazine using each of the multiple pieces of normal vibration data. Then, the estimator 102 may estimate that the attachment state of the tool relative to the tool magazine is normal if it has been estimated that the attachment state is normal based on any of the multiple pieces of the normal vibration data or if it has been estimated that the attachment state is normal with respect to a predetermined number, which is defined in advance, of the pieces of normal vibration data.

Also, normal vibration data acquired from unit types of the machining center 2 may be stored in the normal vibration data storage 140 along with and in association with the unit types of the machining center 2. In this case, the estimator 120 should carry out the estimation process to estimate the attachment state of the tool relative to the tool magazine between the chronological data of the vibration or sound generated in the tool changer acquired by data acquisitor 30 and the normal vibration data which is associated with the unit types of the machining center 2 from which the chronological data of the vibration or sound has been acquired.

In the device 1 having the above-described configuration, detection of an abnormality in attachment of a tool is carried out using the data created by the pre-processor 34 on the basis of the data that has been acquired from the machining center 2 and the sensor 3. The device 1 according to this embodiment carries out the estimation of the attachment state of the tool attached by the operator on the basis of not external appearance but the vibration or sound generated at the time of attachment of the tool. By virtue of this, even when a tool is seemingly appropriately attached but actually it is inappropriately attached due to subtle misalignment or the like, the device 1 is allowed to detect the abnormality of the tool with high precision.

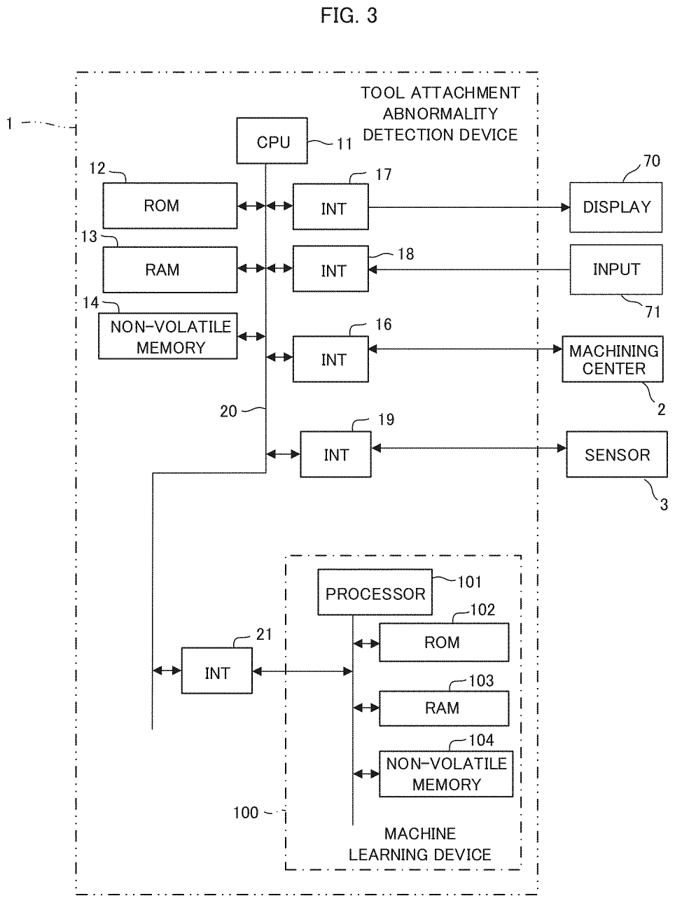

FIG. 3 is a hardware configuration diagram schematically illustrating the principal part of tool attachment abnormality detection device equipped with a machine learning device according to a second or third embodiment.

According to this embodiment, the CPU 11 provided in the tool attachment abnormality detection device 1 is a processor that is responsible for overall control of the device 1. The CPU 11 reads system programs stored in the ROM 12 via the bus 20 to control the entire device 1 in accordance with the system programs. The RAM 13 temporarily may store temporary calculation data, various data input by an operator via the input 71 and so on.

The non-volatile memory 14 may be configured by a memory backed up by a not-shown battery, a solid state drive (SSD) or the like and retains its state of storage even when the device 1 is turned off. The non-volatile memory 14 includes a setting area in which setting information regarding the operation of the device 1 is provided, and stores data input from the input 71, various data acquired from the machining center 2 (operation state regarding tool change, unit types of the machining center or the like), chronological data of various physical quantities acquired from the sensor 3 (vibrations, sound and so on generated in the tool changer provided in the machining center 2). Further, the non-volatile memory 14 may store data read from a not-shown external storage and/or via a network. The programs and the various data stored in the non-volatile memory 14 may be deployed onto the RAM 13 when they are run or used. Also, system programs including a known analysis program for analyzing various data and a program for controlling communications with the machine learning device 100, which will be described later, may be previously written in the ROM 12.

The device 1 according to this embodiment further includes an interface 21, which is an interface for interconnection between the tool attachment abnormality detection device 1 and the machine learning device 100 therein. The machine learning device 100 includes a processor 101 responsible for overall control of the machine learning device 100, the ROM 102 that stores the system programs and the like, the RAM 103 for temporary storage for individual processes associated with the machine learning and the non-volatile memory 104 used to store a learning model and the like. The machine learning device 100 is capable of observing and monitoring, via the interface 21, various pieces of information that can be acquired by the device 1. Here, the information that can be acquired by the device 1 may include, and is not limited to, the operation state regarding tool change, the unit types of the machining center 2 and chronological data of the vibration or sound generated in the tool changer provided in the machining center 2. Also, the device 1 may acquire the result of processing output from the machine learning device 100 via the interface 21, store and display the acquired result and transmit the result to another device via a not-shown network.

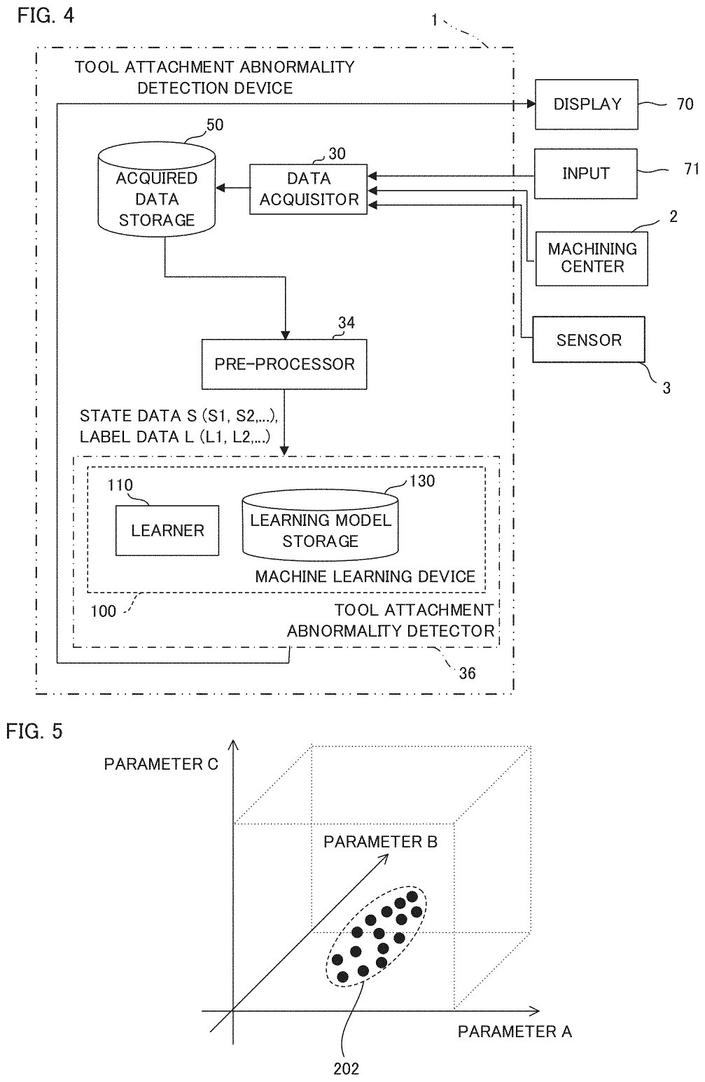

FIG. 4 is a functional block diagram schematically illustrating the tool attachment abnormality detection device 1 and the machine learning device 100 according to the second embodiment. The device 1 according to this embodiment includes a constitution needed for the machine learning device 100 to perform learning (performing a “learning mode”). The individual functional blocks illustrated in FIG. 4 are effectuated by the CPU 11 provided in the device illustrated in FIG. 3 and the processor 101 in the machine learning device 100 executing their respective system programs to control the operations of the individual components of the device 1 and the machine learning device 100.

The device 1 according to this embodiment includes a data acquisitor 30, a pre-processor 34, and a tool attachment abnormality detector 36. The machine learning device 100, which constitutes the tool attachment abnormality detector 36, includes a learner 110. Also, an acquired data storage 50 is provided in the non-volatile memory 14. The acquired data storage 50 stores the data acquired by the data acquisitor 30. The non-volatile memory 104 in the machine learning device 100 constituting the tool attachment abnormality detector 36 includes a learning model storage 130. The learning model storage 130 stores the learning model constructed by machine learning by the learner 110.

The data acquisitor 30 is a functional unit for acquiring various data input from the machining center 2, the sensor 3, the input 71, and the like. The data acquisitor 30 acquires various data such as the operation state regarding tool change, the unit types of the machining center 2, the chronological data of the vibration or sound generated in the tool changer when the tool is attached to the tool magazine by the operator, and information regarding attachment of the tool input by the operator to store these pieces of information in the acquired data storage 50. The data acquisitor 30 may also be configured to acquire the data from a not-shown external storage or from other devices via a wired or wireless network.

The pre-processor 34 creates learning data for use in learning by the machine learning device 100 on the basis of the data acquired by the data acquisitor 30 (and data stored in the acquired data storage 50). The pre-processor 34 creates state data obtained by subjecting the data acquired by the data acquisitor 30 to conversion (for instance, quantification, normalization and sampling) into a unified format to be handled by the machine learning device 100. For example, if the machine learning device 100 carries out unsupervised learning, the pre-processor 34 creates, as the learning data, state data S having a predetermined format according to the unsupervised learning. If the machine learning device 100 carries out supervised learning, the pre-processor 34 creates, as the learning data, a set of state data S and label data L having a predetermined format according to the supervised learning.

The state data S created by the pre-processor 34 includes at least tool attachment vibration data S1. The tool attachment vibration data S1 is chronological data of the vibration or sound generated in the tool changer detected by the sensor 3 when the tool is attached to the tool magazine by the operator. As the tool attachment vibration data S1, it is possible to use data obtained by representing the chronological data of the vibration or sound generated in the tool changer at the time of attachment of the tool detected by the sensor 3 as affiliated data that has been subjected to re-sampling at a predetermined cycle. Also, it is possible to use data indicative of the characteristic of the chronological data (such as known Mel-frequency cepstrum coefficient).

Also, when the label data L is included in the learning data created by the pre-processor 34, the label data L includes at least tool attachment state data L1. The tool attachment state data L1 indicates the information regarding normality/abnormality of attachment of tool at the time of attachment of the tool by the operator. For example, an input value that is input from the input 71 and indicative of the result of manual confirmation of the attachment state of the tool by the operator after the operator attached the tool can be used as the tool attachment state data L1.

The learner 110 carries out machine learning using the learning data created by the pre-processor 34. The learner 110 carries out machine learning using the data acquired from the machining center 2 in accordance with a known scheme of machine learning such as unsupervised learning and supervised learning to generate a learning model, and stores the created learning model in the learning model storage 130. As schemes of unsupervised learning carried out by the learner 110, for example, autoencoder and k-means may be mentioned. As schemes of supervised learning, for example, multilayer perceptron, recurrent neural network, long short-term memory and convolutional neural network may be mentioned.

As an example of machine learning by the learner 110, unsupervised learning based on the state data S created by the pre-processor 34 may be carried out on the basis of data that has been acquired when the tool was correctly attached to the tool changer provided in the machining center 2. In this way, the distribution (cluster) of the learning data acquired in a state where the attachment of the tool to the tool magazine was correctly carried out can be generated as a learning model.

FIG. 5 is a diagram illustrating an example of a learning model created based on the learning data acquired by unsupervised learning in this embodiment acquired in a state where attachment of the tool to the tool magazine has been correctly carried out. It should be noted that FIG. 5 depicts, for the sake of explanation and simplicity, a learning model by way of an example where only parameters A, B, and C are involved as the state data S, but the actual state data S (for example, the state data S having values for representing the chronological data as its elements) will be represented by a higher-order vector space. If the learning model that has been generated in this manner is to be used, the estimator 120 which will be described later estimates the normality/abnormality in attachment of a tool in accordance with whether or not the data newly acquired from the machining center 2 and the sensor 3 is included in the distribution of the learning data acquired in the state where the attachment of the tool to the tool magazine has been correctly carried out (cluster 202 as the learning model) when the data is compared with the distribution. If it is determined that an abnormality exists, the degree of abnormality as the result of the estimation can be computed in accordance with how far the data is away from the distribution of the learning data.

Also, the learner 110 can also carry out the machine learning on the basis of the data 204 acquired when the tool is correctly attached to the tool changer provided in the machining center 2 and the data 206 acquired when the tool is not correctly attached to the tool changer provided in the machining center 2. For example, the learner 110 carries out supervised learning using the learning data (teaching data) created by the pre-processor 34 adding a label indicative of normality to the data 204 and adding a label indicative of abnormality to the data 206, and can generate, as the learning model, the discrimination boundary 208 between normal data and abnormal data.

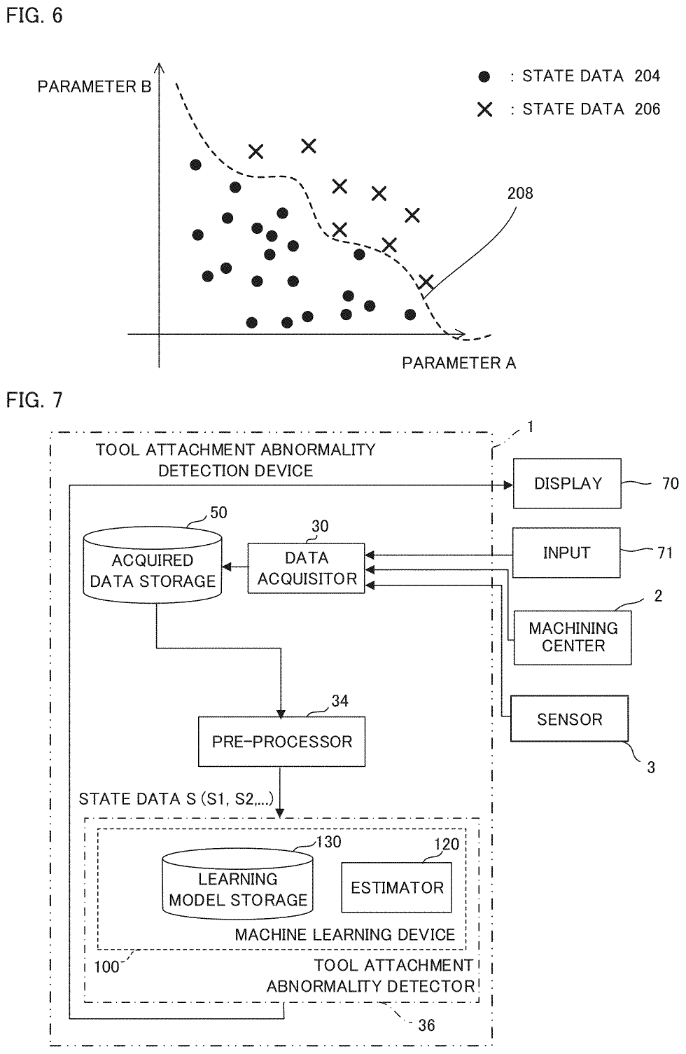

FIG. 6 is a diagram illustrating an example of a learning model created based on the learning data acquired when the attachment of the tool to the tool magazine is carried out according to supervised learning in this embodiment. It should be noted that FIG. 6 depicts, for the sake of explanation and simplicity, a learning model by way of an example where only parameters A and B are involved. However, the actual state data S (for example, the state data S having values for representing the chronological data as its elements) are represented by a higher-order vector space. If the learning model that has been generated in this manner is to be used, the estimator 120 which will be described later estimates the normality/abnormality in attachment of a tool in accordance with in which side the data 204, 206 newly acquired from the machining center 2 and the sensor 3 is plotted with reference to the discrimination boundary 208 as the learning model. If it is determined that an abnormality exists, the degree of abnormality as the estimation result can be computed in accordance with how far the data is away from the discrimination boundary.

In the device 1 having the above-described configuration, the learner 110 carries out machine learning using the learning data created by the pre-processor 34 on the basis of the data acquired from the machining center 2 and the sensor 3. The learning model 208 that has been created in this manner can be used in estimation based on data regarding the vibration or sound generated in the tool changer acquired from the sensor 3 when the tool is attached to the tool magazine by the operator.

FIG. 7 is a functional block diagram schematically illustrating the tool attachment abnormality detection device 1 and the machine learning device 100 according to the third embodiment. The device 1 according to this embodiment includes a constitution needed for the machine learning device 100 to perform estimation (estimation mode). The individual functional blocks illustrated in FIG. 7 are effectuated by the CPU 11 provided in the device 1 illustrated in FIG. 3 and the processor 101 in the machine learning device 100 executing their respective system programs to control the operations of the individual components of the tool attachment abnormality detection device 1 and the machine learning device 100.

The device 1 according to this embodiment includes the data acquisitor 30 and the pre-processor 34, as with the first embodiment. The machine learning device 100 which constitutes the tool attachment abnormality detector 36 includes the estimator 120. Also, the non-volatile memory 14 includes an acquired data storage 50. The acquired data storage 50 stores the learning data used in the estimation of the state by the machine learning device 100. The learning model storage 130 is provided on the non-volatile memory 104 of the machine learning device 100 constituting the tool attachment abnormality detector 36. The learning model storage 130 stores the learning model constructed by the machine learning by the learner 110.

The data acquisitor 30 according to this embodiment is a functional unit for acquiring various data input from the machining center 2, the sensor 3, the input 71 and the like. The data acquisitor 30 acquires various data and has the acquired data stored in the acquired data storage 50. Here, the various data that can be acquired by the data acquisitor 30 may include, and is not limited to, the operation state regarding tool change, the unit types of the machining center 2, the chronological data of the vibration or sound generated in the tool changer when the tool is attached to the tool magazine by the operator, and the information regarding attachment of the tool input by the operator. The data acquisitor 30 may also be configured to acquire the data from a not-shown external storage or from other devices via a wired or wireless network.

The pre-processor 34 according to this embodiment creates state data S for use in estimating by the machine learning device 100 on the basis of the data stored in the acquired data storage 50. The pre-processor 34 creates the state data obtained by subjecting the acquired data to conversion (such as quantification, normalization and sampling) into a unified format to be handled by the machine learning device 100. The state data S created by the pre-processor 34 includes at least tool attachment vibration data S1. The tool attachment vibration data S1 is chronological data of the vibration or sound generated in the tool changer detected by the sensor 3 when the tool is attached to the tool magazine by the operator.

The estimator 120 carries out estimation of the state of the machining center using the learning model stored in the learning model storage 130 on the basis of the state data S created by the pre-processor 34. In the estimator 120 of this embodiment, the state data S that has been input from the pre-processor 34 is input to the learning model generated by (parameters of which are determined by) the learner 110 so as to estimate whether or not the tool has been correctly attached to the tool magazine.

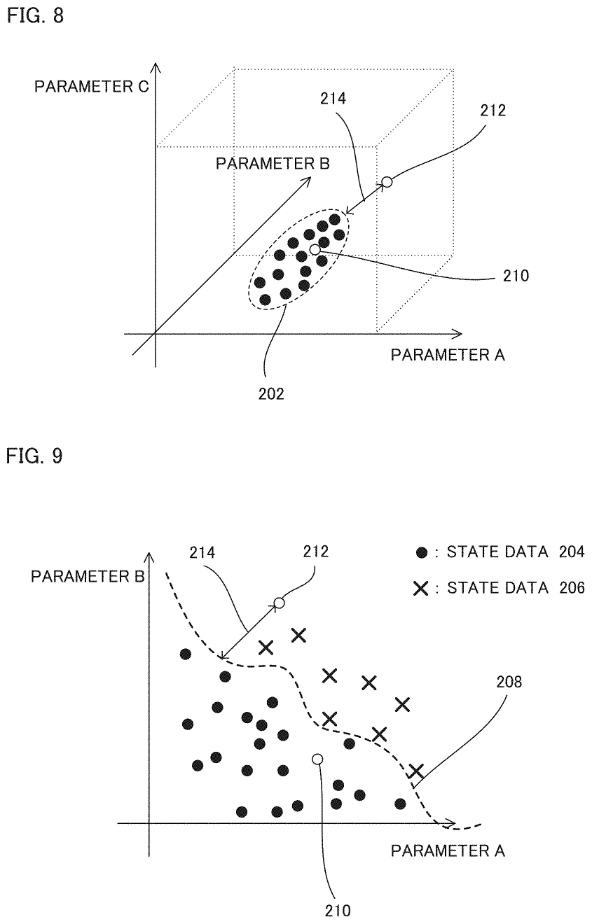

FIG. 8 is a diagram illustrating an example of estimation of normality/abnormality in attachment of a tool using the learning model created by unsupervised learning in this embodiment. It should be noted that FIG. 8 depicts, for the sake of explanation and simplicity, a learning model by way of an example where only parameters A, B, and C are involved as the state data S. However, the actual state data S (for example, the state data S having values for representing the chronological data as its elements) will be represented by a higher-order vector space. When the estimation is carried out using the learning model created by unsupervised learning, whether or not the attachment of the tool was normal or abnormal is estimated in accordance with whether the state data S input as the target of estimation falls within the distribution of the learning data (cluster 202) created as the learning model or resides outside the distribution. In the Figures, the state data detected when the attachment of the tool is normal is indicated by the reference numeral 210. On the contrary, the state data detected when it is abnormal is indicated by the reference numeral 212. Also, when the estimator 120 detects the state data 212 and estimates that the attachment of the tool is abnormal, the estimator 120 can further compute the degree of abnormality 214 on the basis of the distance between the state data and the cluster.

FIG. 9 is a diagram illustrating an example of estimation of normality/abnormality in attachment of a tool using the learning model created by supervised learning in this embodiment. It should be noted that FIG. 9 depicts, for the sake of explanation and simplicity, a learning model by way of an example where only parameters A and B are involved. However, the actual state data S (for example, the state data S having values for representing the chronological data as its elements) will be represented by a higher-order vector space. When the estimation is carried out using the learning model created by supervised learning, whether or not the attachment of the tool was normal or abnormal is estimated in accordance with which of the sides demarcated by the discrimination boundary 208, created as the learning model, the state data S input as the target of estimation resides on. Also, when it has been estimated that an abnormality exists, the degree of abnormality 214 can further be computed on the basis of the distance between the state data and the discrimination boundary 208.

The result of the estimation by the estimator 120 (for example, normality/abnormality in attachment of a tool, the degree of abnormality if occurrence thereof has been estimated) may be displayed and output on the display 70 and may be transmitted and output via a not-shown wired or wireless network to host computer, a cloud computer or the like to be used thereby. The device 1 may also be configured to change the display state of the display 70 according to the magnitude of the degree of abnormality.

In the device 1 having the above-described configuration, estimation of normality/abnormality in attachment of a tool is carried out using the state data created by the pre-processor 34 on the basis of the data acquired from the machining center 2 and the sensor 3. The device 1 according to this embodiment carries out the estimation of the attachment state of the tool attached by the operator on the basis of not external appearance but the vibration or sound generated at the time of attachment of the tool. By virtue of this, even when a tool is seemingly appropriately attached but actually it is inappropriately attached due to subtle misalignment or the like, it is made possible to detect the abnormality of the tool with high precision.

Whilst the embodiments of the present invention have been described in the foregoing, the present invention is not limited to the above-described embodiments and can be implemented in various modes with various modifications made thereto as appropriate.

For example, although the above-mentioned second and third embodiments have been described on the assumption that the tool attachment abnormality detection device 1 and the machine learning device 100 are devices each having a central processing unit or processor different than that of each other, the machine learning device 100 may also be effectuated by the CPU 11 provided in the tool attachment abnormality detection device 1 and the system programs stored in the ROM 12.

Also, while the above-described second and third embodiments have been described on the assumption that the configuration for learning constitute one embodiment and the configuration for estimation constitutes another embodiment different than the former, it is also possible to configure a tool attachment abnormality detection device 1 incorporating both of these configurations. In this case, the device 1 will operate so as to update (learn) the learning model as required while carrying out the estimation of the attachment state of the tool.

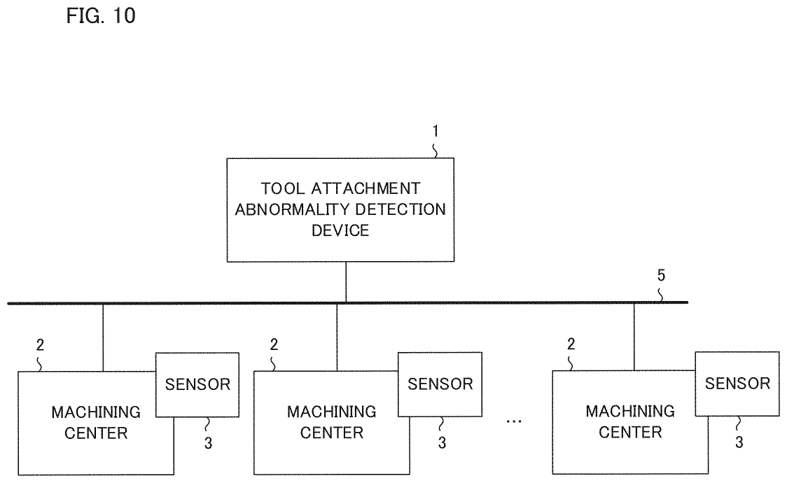

Furthermore, for example, the tool attachment abnormality detection device 1 may be mounted on a host computer, a cloud server and so on. As illustrated in FIG. 10, if the tool attachment abnormality detection device 1 is connected via a wired or wireless network 5 to a plurality of machining centers 2 and the sensors 3 each attached to the corresponding one of these machining centers 2, then the device 1 may be configured to collect data from the respective machining centers 2 and their sensors 3 and detect normality/abnormality of the attachment state of the tool relative to the tool magazine in each of the machining centers 2.

1. A device for detecting an abnormality in attachment of a tool to a tool magazine in a tool changer provided in a machining center, the device comprising:
a data acquisitor for acquiring data regarding the machining center;
a pre-processor for creating data regarding at least chronological data of vibration or sound generated in the tool changer when the tool is attached to the tool magazine, the data regarding the at least chronological data being created based on the data acquired by the data acquisitor; and
a tool attachment abnormality detector for detecting an abnormality in attachment of the tool to the tool magazine based on the data created by the pre-processor.

2. The device according to claim 1, wherein
the device is connected via a network to a plurality of machining centers, and
based on data acquired from the plurality of machining centers, the abnormality in attachment of the tool to the tool magazine in the tool changer each provided in corresponding one of the plurality of machining centers is detected.

3. A device for detecting an abnormality in attachment of a tool to a tool magazine in a tool changer provided in a machining center, the device comprising:
a data acquisitor for acquiring data regarding the machining center;
a pre-processor for creating state data that includes at least tool attachment vibration data regarding chronological data of a vibration or sound generated in the tool changer when the tool is attached to the tool magazine, the state data being created as learning data based on the data acquired by the data acquisitor; and
a tool attachment abnormality detector configured for detection of an abnormality in attachment of the tool to the tool magazine based on the data created by the pre-processor, the tool attachment abnormality detector including a learner for performing machine learning using learning data created by the pre-processor and further creating a learning model for detection of an abnormality in attachment of the tool to the tool magazine.

4. The device according to claim 3, wherein the learning model is generated by unsupervised learning.

5. The device according to claim 3, wherein the learning model is generated by supervised learning.

6. The device according to claim 3, wherein
the device is connected via a network to a plurality of machining centers, and
based on data acquired from the plurality of machining centers, a learning model is generated which is configured for detection of the abnormality in attachment of the tool to the tool magazine in the tool changer each provided in corresponding one of the plurality of machining centers.

7. A device for detecting an abnormality in attachment of a tool to a tool magazine in a tool changer provided in a machining center, the device comprising:
a data acquisitor for acquiring data regarding the machining center;
a pre-processor for creating state data that includes at least tool attachment vibration data regarding chronological data of a vibration or sound generated in the tool changer when the tool is attached to the tool magazine, the state data being created based on the data acquired by the data acquisitor; and
a tool attachment abnormality detector for detecting an abnormality in attachment of the tool to the tool magazine based on the data created by the pre-processor, the tool attachment abnormality detector including:
a learning model storage configured to store a learning model for learning an attachment state of the tool attached to the tool magazine with respect to chronological data of a vibration or sound generated in the tool changer when the tool is attached to the tool magazine; and
an estimator configured to estimate the attachment state of the tool attached to the tool magazine by using the learning model stored in the learning model storage, the attachment state being estimated based on the state data created by the pre-processor.

8. The device according to claim 7, wherein the learning model is generated by unsupervised learning.

9. The device according to claim 7, wherein the learning model is generated by supervised learning.

10. The device according to claim 7, wherein
the device is connected via a network to a plurality of machining centers, and
based on data acquired from the plurality of machining centers, the abnormality in attachment of the tool to the tool magazine of the tool changer each provided in corresponding one of the plurality of machining centers are detected.
